(19) United States
(12) Patent Application Publication
(10) Pub. No.: US 2019/0110949 A1
(43) Pub. Date: Apr. 18, 2019

(54) HAND-ATTACHED CONTROLLED PULSED VIBRATION DEVICE

(71) Applicant: Raja Bhatti, Arlington, TX (US)

(72) Inventor: Raja Bhatti, Arlington, TX (US)

(21) Appl. No.: 15/786,737

(22) Filed: Oct. 18, 2017

(51) Int. Cl. A61H 23/02

(52) U.S. Cl. CPC A61H 23/02; A61H 2023/002

(57) ABSTRACT

A hand-attached controlled pulsed vibration device, allowing for transmission of an enhanced massage, allowing full skin-to-skin contact between the hand of the person giving a massage and the skin of the person receiving the massage, by mounting on the back of the hand, with no glove, partial glove, or straps on the palm-side of the hand, and providing for vibration of controllable intensities and cycle times not normally achievable from a small vibrating motor, by controlling the electric power provided to one or more small vibrating motors, such that the operation of one motor or the interactions between two or more motors result in desirable intensities and cycle times of overall vibration.

### BACKGROUND

This invention is a hand-attached controlled pulsed vibration device, used for giving an enhanced massage, allowing for full skin-to-skin contact between the hand of the person giving a massage and the skin of the person receiving the massage.

Presently known hand-attached devices of this type are mounted to the hand using a glove, partial glove, or straps, which interfere with full skin-to-skin contact between the hand of the person giving a massage and the skin of the person receiving the massage. However, the skin-to-skin contact is considered by some to be an important aspect of the massage, and interference with this contact is not favored.

Further, addition of the proper vibration to the hand of the person giving a massage is known to be beneficial and desirable in some circumstances. One of the major benefits of a massage is achieved by the breaking up and dislodging of crystals of lactic acid, which form within muscle tissue under conditions of activity or tension, where the broken-up lactic-acid crystals are then re-dissolved into the blood, which in turn flushes the lactic acid out of the muscle tissue. The massage is thought to both break up the crystals and increase the flushing movement of blood through the targeted muscle tissue, both of which are beneficial actions.

The amount and quality of the vibration applied to and through the hand of the person giving a massage is an important consideration. For example, vibrations in the ultrasonic range might be effective for breaking down crystals, but such fast vibrations cannot be effectively transmitted through the hand of the person giving a massage, because the hand would absorb the ultrasonic energy, causing discomfort or damage to the hand of the person giving the massage, and without transferring any significant benefit to the person receiving the massage. Within the range of intensities and frequencies of vibration that can be applied to and transmitted through the hand (which are all fairly high frequencies in relation to the whole range of possibilities), frequencies at the lower end of the range and amplitudes or intensities at the higher end of the range are considered to be most effective and most comfortable, and therefore most desirable.

Presently known hand-attached devices of this type either contain a large heavy motor, with an eccentric weight, to achieve the desirable amplitudes or intensities of vibration at desirable frequencies or cycle times, or use a smaller motor, which cannot, on their own, provide the desirable intensities and frequencies of vibration, but instead provide more of a buzzing effect.

For example, U.S. Pat. No. 2,018,046 issued to G. A. Wilson on Oct. 22, 1935 for a “Vibrator.” The Wilson patent discloses a vibrator of a general nature, with a rigid casing, an electric motor within the casing, and means driven from the motor adapted to vibrate the casing, where the casing in turn comprises a body portion, within which the motor is positioned, and an extension in the direction of the wrist of the hand upon which it is mounted, with controlling means within the extension adapted to control the rate of rotation of the motor, and where the extension is downwardly inclined with respect to the body of the casing, as well as yielding means adapted to extend about the hand, where the yielding means are also connected to the casing, and means adapted to extend about the hand and connect to the extension.

U.S. Pat. No. 2,287,501 was issued on Jun. 23, 1942 to William A. Thomas, also disclosing a “Vibrator”, and more specifically a self-contained electric hand-vibrator, incorporating a vibratory electric motor and adapted to be mounted on the back of the hand to vibrate the fingers of the wearer, the fingers in turn being applied as massage elements to the portion of the anatomy to be treated. In order to hold the vibrator in position on the hand, a strap or band is provided, to be worn around the hand of the wearer.

U.S. Pat. No. 7,300,409, issued to Robert J. Kopanic, J R. et al. on Nov. 27, 2007, covers a “Therapy Patch.” The therapy patch provides portable massaging devices that can also delivery topical treatment chemicals. The patches can be adhered to the skin via an adhesive layer that is also impregnated with the treatment chemical. Kits are also provided to create a string of linked patches that can be used together or separately, and a microcontroller controls the vibration of the device for optimized massaging effects.

U.S. Publication No. 2008/0216207 was published on Sep. 11, 2008 by Shen-Hai Tsai, disclosing a “Finger Pressing Massage Glove.” The concept provides for a fingertip massaging glove, and particularly a glove massager to facilitate a user in operation according to his preference. The glove massager includes a glove fit out one's hand for vibration; a vibration device enclosed inside of the glove that includes a panel with an interface displayed on a hand back of the glove; and a number of eccentric vibrators connected to the panel by leads. A set of batteries are disposed inside the panel to supplement power to the glove. When the vibrators are powered to vibrate, the affected part of the user can be relieved of pain or soreness.

U.S. Publication No. 2012/0136288, published by Deborah Napier on May 31, 2012, discloses “Heat Massage Gloves.” The heated massage glove comprises a hand covering to envelope a hand of a user, a set of finger segments to accept the fingers of the user, a set of finger massagers attached within the set of finger segments, where the set of finger massagers vibrate and pulse against the set of fingers, a set of hand massagers attached to a backside of the hand covering, wherein the set of hand massagers vibrate and pulse against a backside of the hand, a heating apparatus housed within the hand covering, where the heating apparatus includes a plurality of wires to heat the hand covering, and a control mechanism attached to the backside of the hand, covering wherein the control mechanism that controls the intensity of the set of finger massagers and the set of hand massagers, as well as how intense the heating apparatus heats.

U.S. Publication No. 2014/0243589, disclosing a “Disposable Vibratory Apparatus,” was published on Aug. 28, 2014 by Kinkel Rowan. The device includes a patch enclosing a battery and a vibratory element with a removable, nonconductive tab for turning the apparatus on or off. The apparatus may be applied, directly, to a target area of the human body via an adhesive layer, to provide a vibratory sensation for therapeutic or pleasurable purposes. The vibratory apparatus configuration comprises minimal components within the patch, providing portability and freedom of movement without an external controller or power source.

Lastly, U.S. Publication No. 2017/0036009 was published by Clint Hughes et al. on Feb. 9, 2017, and discloses a “TENS with Vibration and/or Mechanical Muscular Manipulation.” The publication discloses a transcutaneous electrical nerve simulation (“TENS”) device and method using a microcurrent with a carrier signal and a square wave form, combined with vibration and/or mechanical muscular manipulation for promoting the release and disbursement of lactic acid, treating muscle soreness, cramping, or degeneration. The method and nerve simulation device is packaged to require no input from a user, and the user must only apply the sticky electrode pad, featuring a base unit attached on top, to the correct part of the body, and start the preprogrammed sequence of electrical currents, vibration, and/or muscular manipulation. The method involves applying bursts of direct current at higher frequencies for shorter periods of time, followed by lower frequency bursts of electrical current for longer periods of time, combined with a small vibration motor and/or motorized nodes, providing muscular manipulation to certain areas of the body.

There is, accordingly, a need for a device which mounts to the back of the hand in a manner that allows for full skin-to-skin contact, and being of small size and weight, but achieving deeper, slower vibrations from a motor small enough to fit comfortably on the back of the hand.

### SUMMARY OF THE INVENTION

This invention provides a hand-attached controlled pulsed vibration device, providing an enhanced massage, allowing full skin-to-skin contact between the hand of the person giving a massage and the skin of the person receiving the massage, by mounting on the back of the hand with no glove, partial glove, or straps on the palm-side of the hand, and further providing vibration of controllable intensities and cycle times not normally achievable from a small vibrating motor, by controlling the electric power provided to one or more small vibrating motors, such that the operation of one motor or the interactions between two or more motors result in desirable intensities and cycle times of overall vibration.

### BRIEF DESCRIPTION OF DRAWINGS

Reference will now be made to the drawings, wherein like parts are designated by like numerals, and wherein:

FIG. 1 is a perspective view of the hand-attached controlled pulsed vibration device of the invention in use;

FIG. 2 is an exploded perspective view of the hand-attached controlled pulsed vibration device of the invention;

FIG. 3 is a schematic hidden-line view of the internal components of the hand-attached controlled pulsed vibration device of the invention;

FIG. 4 is an exploded side view of the hand-attached controlled pulsed vibration device of the invention;

FIG. 5 is a schematic hidden-line view of an embodiment of the hand-attached controlled pulsed vibration device of the invention, having two motors mounted in matching orientation;

FIG. 6 is a schematic hidden-line view of another embodiment of the hand-attached controlled pulsed vibration device of the invention, having three motors mounted in different orientations;

FIG. 7 is a perspective view of an embodiment of the hand-attached controlled pulsed vibration device of the invention, having a display separate from multiple control buttons;

FIG. 8 is a perspective view of an embodiment of the hand-attached controlled pulsed vibration device of the invention, having a touch-sensitive display incorporating multiple control buttons;

FIG. 9 is a schematic view of an embodiment of the hand-attached controlled pulsed vibration device of the invention, having a remote unit; and

FIG. 10 is a schematic view of an embodiment of the hand-attached controlled pulsed vibration device of the invention, having an external power source.

### DETAILED DESCRIPTION OF THE INVENTION

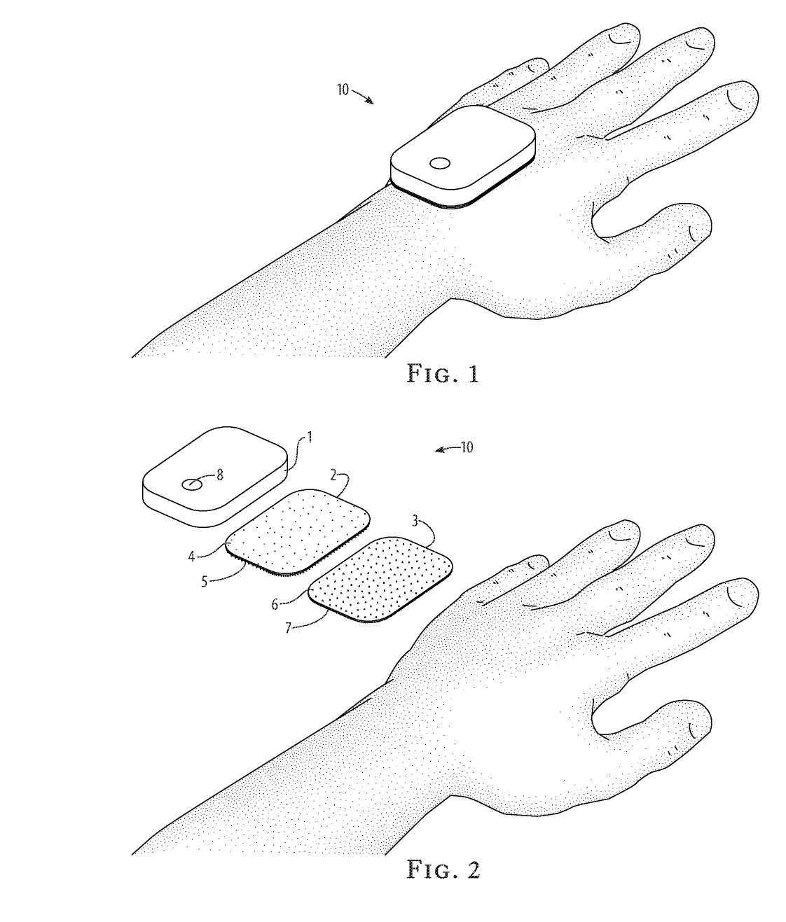

Referring to FIG. 1 and all of the figures generally, the hand-attached controlled pulsed vibration device 10 of the invention is shown. The hand-attached controlled pulsed vibration device 10 provides a unit body 1 which is removably attached to the back of a hand of a person giving a massage without any glove, or bands, or any other material that would cover the skin of the palm-side of the hand or would cover the fingers. By not covering the palm-side of the hand or the fingers, the hand-attached controlled pulsed vibration device 10 allows full skin-to-skin contact between the hand of the person giving a massage and the skin of the person receiving the massage.

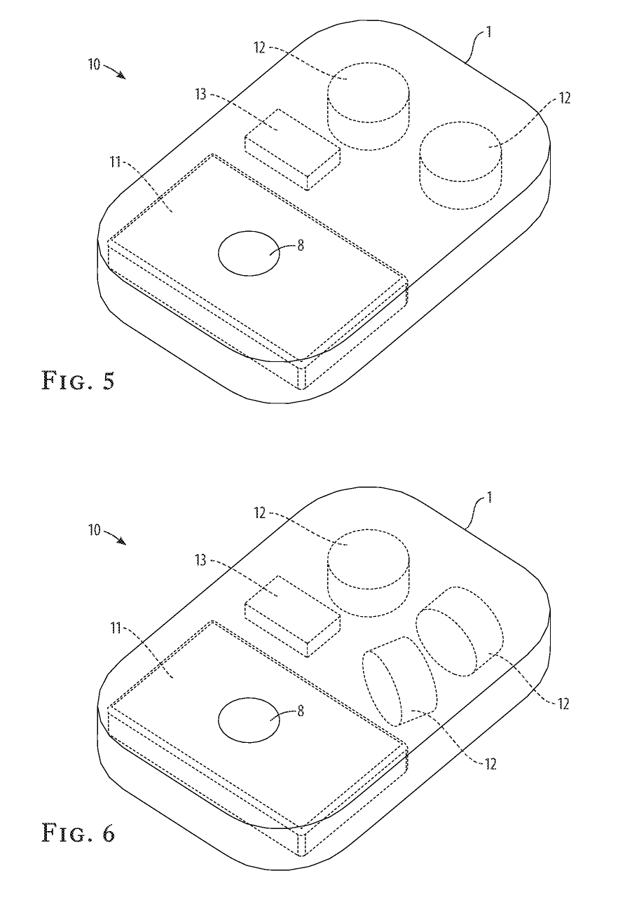

Referring to FIG. 2 & FIG. 4, in a preferred embodiment of the hand-attached controlled pulsed vibration device 10, removable, replaceable, and reposition-able attachment of the unit body 1 to the back of the hand is achieved through the removable attachment of a skin patch 3 to the back of the hand with skin adhesive 7, attachment of an intermediate patch 2 to the bottom of the unit body 1 with adhesive 4, and then the removable attachment of the intermediate patch 2 to the skin patch 3, using known methods such as the provision of a layer of attachment hooks 5 on the bottom of the intermediate patch 2 and a layer of attachment loops 6 on the top of the skin patch 3, to provide the known hook-and-loop type of removable, replaceable, and reposition-able attachment.

The skin adhesive 7 should be one that will adequately hold to an active hand, and that will not irritate the skin of the back of the hand. In order to provide an adequate hold, the skin adhesive 7 might be one that is more easily removed with a non-irritating solvent or removed by the application of a type and a direction of force that is unlikely to be applied in normal use, such as a simultaneous twisting and lifting force.

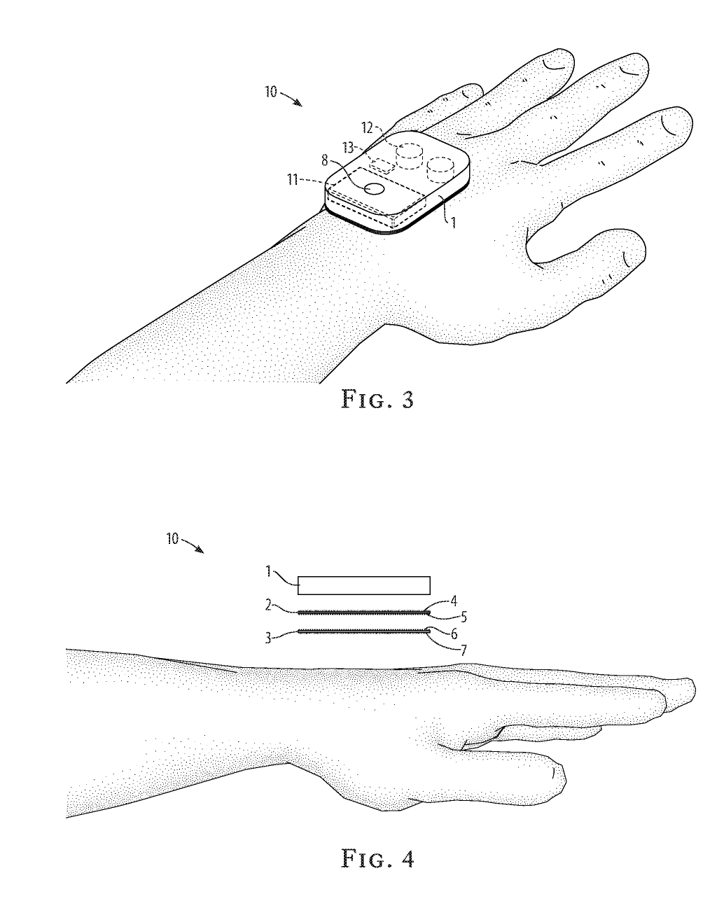

Referring to FIG. 3, inside the unit body 1 are one or more motors 12 which provide the vibrating actions of the hand-attached controlled pulsed vibration device 10. Each motor 12 might be an Eccentric Rotating Mass (ERM) type electric motor or a Linear Resonance Actuator (LRA) type electric motor. Depending on the type and size of the motor used, and depending on the manner of mounting and the power supplied, different motors will have different vibration and resonance characteristics. In embodiments providing at least two motors 12, the motors might be of different types or different sizes, although they can also be of the same type and size, if that is desired.

A battery 11 supplies the electric force for operating the motor or motors 12. The battery might be a flat lithium-polymer rechargeable battery of the type used in cellphones, as is illustrated, or might another type or form of battery, such as a coin-cell battery or an AAA-sized battery. An ultra-capacitor could also function as a battery, as is known in the art.

A controller 13 manages the amount of power from the battery 11 that is supplied to the motor or motors 12. In embodiments having just one motor 12, the controller 13 supplies the electric power in timed pulses calibrated to provide specific, desired vibrational characteristics. Any motor 12 fitted into the unit body 1 must necessarily be small, and therefore will have high natural vibrational frequency and resonance, or a series of such frequencies and resonances. In order to achieve more desirable lower vibrational frequencies, and in order to achieve desirable modifications to the timing or rhythm of the vibration, the controller 13 supplies power to the motor 12 in pulses calibrated to provide the desired effect. By providing or withholding the power in pulses coordinated with the natural vibrational frequencies and resonances, plus the starting, stopping, and other characteristics of the motor 12, the hand-attached controlled pulsed vibration device 10 can produce changes in intensity and timing of the vibration, with higher intensity and slower timing being most likely desired.

In embodiments of the hand-attached controlled pulsed vibration device 10 with at least two motors 12, the interaction among the motors can be controlled by the controller 13 to produce desirable vibrational effects. Two or more motors 12 can be mounted inside the unit body 1 so that the line or plane of their major vibrational forces are aligned, are opposing, or are oblique.

According to the principle of superposition of waves, when two or more propagating waves of the same type are incident on the same point, the resultant amplitude at that point is equal to the vector sum of the amplitudes of the individual waves. When a crest of a wave meets a crest of another wave of the same frequency at the same point, then the amplitude is the sum of the individual amplitudes, in a phenomenon known constructive interference. If a crest of one wave meets a trough of another wave, then the amplitude is equal to the difference in the individual amplitudes, in the phenomenon known as destructive interference.

Constructive interference occurs when the phase difference between the waves is an even multiple of π (180°) such as 2π (360°); destructive interference occurs when the difference is an odd multiple of π (180°). An intermediate phase difference causes a displacement of intermediate magnitude. Where the two or more propagating waves are all of equal constant frequency, then the changes of amplitude will occur in a repeating cycle directly corresponding to the original frequency. Where the frequencies of the two or more propagating waves are different from one another, then the crests and troughs of the waves have more complex relationships and interactions, and the changes of amplitude will occur in a different, more complex cycle that does not directly correspond to any of the original frequencies. This more complex cycle is sometimes referred to as “beats”.

The hand-attached controlled pulsed vibration device 10 of the invention utilizes the principle of superposition of waves to obtain overall vibrational amplitudes and frequencies different from those of the individual contributing motors 12. The hand-attached controlled pulsed vibration device 10 of these embodiments can obtain overall vibrations of amplitude or intensity, and of frequency or timing, of desired values, with higher intensity and slower timing being most likely desired. The controller 13 manages the contributing amplitudes, frequencies, and phases of each individual motor 12 by controlling the electric power provided to each individual motor, so that the desired overall vibrations can be obtained.

Referring to FIG. 5, even where two identical motors 12 are placed in alignment with each other, more intense vibration can be achieved by the controller 13, ensuring that the force from the two motors add together for an increase in intensity, rather than canceling each other for a decrease in intensity. Also, two identical motors can be operated at different speeds, which would allow for a pulsing of intensity with slower timing, because the forces of the motors will intermittently add and cancel each other.

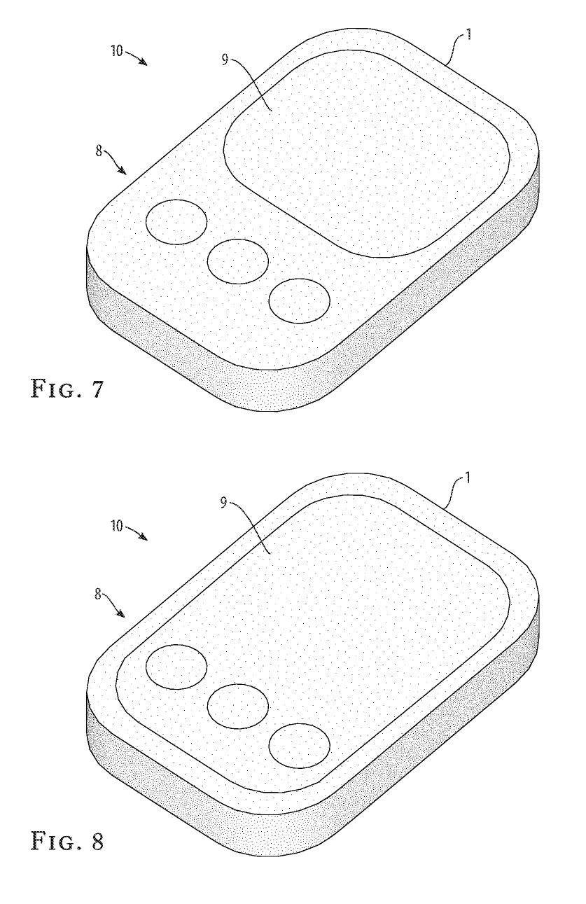

Referring to FIG. 6, additional vibrational variety can be provided using at least two motors 12 having differing natural vibrational frequencies and resonances, and by mounting motors in relative positions in which the lines or planes of their major vibrational forces are at an angle to each other. Again, with the proper control from the controller 13, the intensity and timing of the combined vibration can be changed.

Referring now to FIG. 7 & FIG. 8, the hand-attached controlled pulsed vibration device 10 provides at least one control button 8 on the unit body 1. In a simple embodiment, a single control button 8 could function as a simple on-off switch, or could provide more control based on multiple pushes or holding of the button. In an embodiment providing additional control buttons 8, easier control of additional operating parameters can be provided.

Optionally, a display 9 can be provided. Such a display 9 might be of more use where, in addition to displaying the operational parameters, additional features such as timers, event counters, or accelerometers are also incorporated. The optional display 9 might cover a part of, or essentially the whole top face, of the unit body 1, as illustrated. Where a touch-sensitive display is used, the control button or buttons 8 can be implemented as a component of the display.

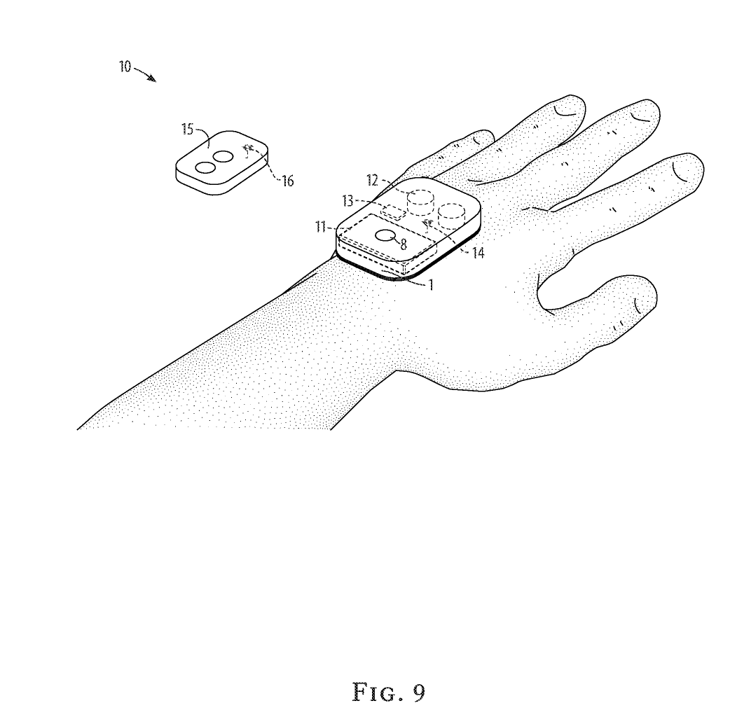

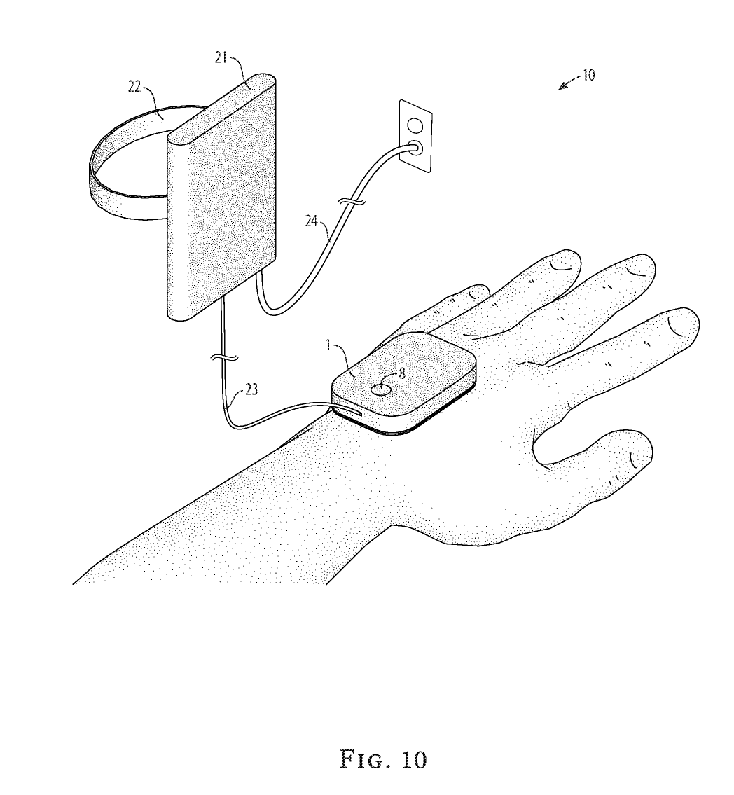

Referring to FIG. 9, an alternative embodiment of the hand-attached controlled pulsed vibration device 10 also provides a remote unit 15 for remote control of the operating parameters, such as on-off state, intensity, and timing of the vibration of the hand-attached controlled pulsed vibration device. The remote unit 15 might be used by the person giving a massage, or by the person receiving the massage. The remote unit 15 communicates wirelessly with the unit body 1 through a unit antenna 14 incorporated into the unit bodyl, and a corresponding remote antenna incorporated into the remote unit 15.

Referring to FIG. 10, another alternative embodiment of the hand-attached controlled pulsed vibration device 10 also provides an external power source 21 to provide either supplemental power, or the main power for operating the hand-attached controlled pulsed vibration device 10. The external power source can provide a strap 22 for attachment, which would likely be an attachment to the upper arm or to the forearm of the person giving the massage. The external power source 21 provides power to the unit body 1 through a power cable 23, which should be flexible and connected with sufficient looseness or play to allow full movement of the hand and wrist. The external power source 21 can be recharged from another source, such as mains electricity, through a recharging cord 24, which can be removed or retracted during use of the hand-attached controlled pulsed vibration device 10.

Many other changes and modifications can be made in the system and method of the present invention without departing from the spirit thereof. We therefore pray that our rights to the present invention be limited only by the scope of the appended claims.

I claim:

1. A hand-attached controlled pulsed vibration device, for use by a first person giving a massage, said first person having a hand, and said hand having a nominal back and front side, and a second person receiving a massage, said device comprising:
(i) a unit body adapted to be removably mounted on the back of the hand of the person giving a massage, allowing full skin-to-skin contact between the hand of the first person giving the massage and the skin of the second person receiving the massage;
(ii) a motor mounted inside said unit body, adapted to vibrate in response to the application of electric power;
(iii) a battery mounted inside said unit body, adapted to provide electric power for said motor;
(iv) a controller mounted inside said unit body, adapted to regulate the electric power supplied to said motor; and
(v) at least one control button mounted on said unit body, adapted to control the operation of said controller;
where, in use, said controller regulates the electric power from said battery supplied to said motor in a pulsed manner such as to cause an additional vibration of a different amplitude and a different frequency; and
where, in use, the additional vibration resulting from the operation of said controller is transferred from the hand of the first person giving the massage to the skin of the second person receiving the massage.

2. The hand-attached controlled pulsed vibration device of claim 1, further comprising a display mounted on said unit body.

3. The hand-attached controlled pulsed vibration device of claim 1, further comprising a touch-sensitive display mounted on said unit body.

4. The hand-attached controlled pulsed vibration device of claim 1, further comprising a touch-sensitive display incorporating said at least one control button, mounted on said unit body.

5. The hand-attached controlled pulsed vibration device of claim 1, where said removable mounting of the unit body to the back of the hand of the first person giving the massage further comprises:
(i) a skin patch adapted to be removably mounted on the back of a hand by an incorporated skin adhesive on a bottom face, and having on the top face a surface adapted to provide a top-facing mounting surface; and
(ii) an intermediate patch adapted to be mounted on the bottom of said unit body by an incorporated adhesive on a top face, and having on the bottom face a surface adapted to provide a bottom-facing mounting surface corresponding to the top-facing mounting surface of said skin patch.

6. The hand-attached controlled pulsed vibration device of claim 1, where the removable mounting of said unit body to the back of the hand of the first person giving the massage further comprises:
(i) a skin patch adapted to be removably mounted on the back of a hand by an incorporated skin adhesive on a bottom face, and having on the top face a surface adapted to provide a top-facing mounting surface with attachment loops; and
(ii) an intermediate patch adapted to be mounted on the bottom of said unit body by an incorporated adhesive on a top face, and having on the bottom face a surface adapted to provide a bottom-facing mounting surface with attachment hooks, corresponding to the top-facing mounting surface of said skin patch.

7. The hand-attached controlled pulsed vibration device of claim 1, where said motor is an Eccentric Rotating Mass (ERM) type electric motor.

8. The hand-attached controlled pulsed vibration device of claim 1, where said motor is a Linear Resonance Actuator (LRA) type electric motor.

9. The hand-attached controlled pulsed vibration device of claim 1, further comprising a remote unit adapted to provide remote control of the operations of said controller in said unit body.

10. The hand-attached controlled pulsed vibration device of claim 1, further comprising a remote unit having a remote antenna, and a unit antenna incorporated in said unit body, adapted to provide wireless remote control of the operations of said controller in said unit body.

11. The hand-attached controlled pulsed vibration device of claim 1, further comprising an external power source.

12. The hand-attached controlled pulsed vibration device of claim 1, further comprising an external power source having a strap for attachment to the arm of the person giving the massage, having a power cable adapted to provide power to said unit body, and having a recharging cord adapted to accept power from mains electricity.

13. A hand-attached controlled pulsed vibration device, for use by a first person giving a massage, said first person having a hand, and said hand having a nominal back and front side, and a second person receiving a massage, said device comprising:
(i) a unit body adapted to be removably mounted on the back of the hand of the first person giving a massage, allowing full skin-to-skin contact between the hand of the first person giving the massage and the skin of the second person receiving the massage;
(ii) at least two motors mounted inside said unit body, adapted to vibrate in response to the application of electric power;
(iii) a battery mounted inside said unit body, adapted to provide electric power for said motors;
(iv) a controller mounted inside said unit body, adapted to regulate the electric power supplied to said motors; and
(v) at least one control button mounted on said unit body, adapted to control the operation of said controller;
where, in use, said controller regulates the electric power from said battery supplied to said motors in a manner so as to cause an additional vibration of a different amplitude and a different frequency by manipulation of constructive and destructive interference among the motors; and
where, in use, the additional vibration resulting from the operation of said controller is transferred from the hand of the first person giving the massage to the skin of the second person receiving the massage.

14. The hand-attached controlled pulsed vibration device of claim 13, further comprising a display mounted on said unit body.

15. The hand-attached controlled pulsed vibration device of claim 13, further comprising a touch-sensitive display mounted on said unit body.

16. The hand-attached controlled pulsed vibration device of claim 13, further comprising a touch-sensitive display incorporating said at least one control button, mounted on said unit body.

17. The hand-attached controlled pulsed vibration device of claim 13, where the removable mounting of said unit body to the back of the hand of the person giving the massage further comprises:
(i) a skin patch adapted to be removably mounted on the back of a hand by an incorporated skin adhesive on a bottom face, and having on the top face a surface adapted to provide a top-facing mounting surface; and
(ii) an intermediate patch adapted to be mounted on the bottom of said unit body by an incorporated adhesive on a top face, and having on the bottom face a surface adapted to provide a bottom-facing mounting surface corresponding to the top-facing mounting surface of said skin patch.

18. The hand-attached controlled pulsed vibration device of claim 13, where the removable mounting of said unit body to the back of the hand of the person giving the massage further comprises:
(i) a skin patch adapted to be removably mounted on the back of a hand by an incorporated skin adhesive on a bottom face, and having on the top face a surface adapted to provide a top-facing mounting surface with attachment loops; and
(ii) an intermediate patch adapted to be mounted on the bottom of said unit body by an incorporated adhesive on a top face, and having on the bottom face a surface adapted to provide a bottom-facing mounting surface with attachment hooks, corresponding to the top-facing mounting surface of said skin patch.

19. The hand-attached controlled pulsed vibration device of claim 13, where at least one said motor is an Eccentric Rotating Mass (ERM) type electric motor.

20. The hand-attached controlled pulsed vibration device of claim 13, where at least one said motor is a Linear Resonance Actuator (LRA) type electric motor.

21. The hand-attached controlled pulsed vibration device of claim 13, where at least one said motor is mounted in said unit body in a position such that its line or plane of major vibration is perpendicular or oblique to that of another said motor.

22. The hand-attached controlled pulsed vibration device of claim 13, further comprising a remote unit having a remote antenna, and a unit antenna incorporated in said unit body, adapted to provide wireless remote control of the operations of said controller in said unit body.

23. The hand-attached controlled pulsed vibration device of claim 11, further comprising an external power source.

24. The hand-attached controlled pulsed vibration device of claim 11, further comprising an external power source having a strap for attachment to the arm of the person giving the massage, having a power cable adapted to provide power to said unit body, and having a recharging cord adapted to accept power from mains electricity.
